(19) United States
(12) Patent Application Publication
(10) Pub. No.: US 2026/0091998 A1
(43) Pub. Date: Apr. 2, 2026

(54) H2S SEQUESTERING COMPOSITION

(71) Applicant: C.I MULTISERVICIO DE INGENIERIA 1A S.A, Barrancabermeja (CO)

(72) Inventors: Nilson AHUMADA ANGEL, Barrancabermeja (CO); Carlos Andres HERNANDEZ BARRIOS, Barrancabermeja (CO); Neils LEAL GODOY, Barrancabermeja (CO)

(21) Appl. No.: 19/111,639

(22) PCT Filed: Sep. 13, 2023
(86) PCT No.: PCT/IB2023/059078

§ 371 Date: Mar. 13, 2025

(30) Foreign Application Priority Data
Sep. 15, 2022 (CO) NC2022/0013199

(51) Int. Cl. C02F 1/68; B01J 20/22; B01J 20/28; B01J 20/30; B01J 20/32; C02F 101/10

(52) U.S. Cl. CPC C02F 1/683; B01J 20/22; B01J 20/28016; B01J 20/3085; B01J 20/3204; B01J 20/3217; B01J 20/3246; B01J 20/3293; C02F 2101/101

(57) ABSTRACT

The present development refers to a H₂S sequestrant composition in wastewater comprising°aminoorganoalkoxysilane-functionalized°particles, aminoorganoalkoxysilane-functionalized thickening agents, an adsorption promoter, and a polar solvent. In particular, the developed composition allows the removal of H₂S present in wastewater due to the combined reaction of the amino groups on the particles and the aminoorganoalkoxysilane-functionalized thickening agents and the H₂S that, in the presence of the absorption promoter, allows the production of ammonium hydrogen sulfide (NH₄SH). In addition, the sequestrant composition of the present development maintains the H₂S species captured without further release into the atmosphere.

### TECHNICAL FIELD

The composition of the present development belongs to the chemical engineering field, particularly, the technical field of hydrogen sulfide (H₂S) sequestrant compositions, preparation methods thereof, and use thereof for reducing H₂S concentration in wastewater.

### DESCRIPTION OF THE PRIOR ART

The H₂S occurs naturally and as a product of human activities including oil refineries, natural gas plants, petrochemical plants, coke oven plants, food processing plants, and tanneries. The H₂S is colorless, poisonous, naturally-corrosive, and considered a primary environmental pollutant that can easily dissolve in oil, water, alcohol, and some other solvents. Some inhalations of H₂S gas are sufficient to induce various health complications, such as lung failure, collapse, coma, and death.

Additionally, the H₂S can create corrosion problems in transportation pipelines, drill strings, and storage tanks; sulfide stress cracking; pitting corrosion; scale formation; and hydrogen embrittlement in oil and gas operations. In order to mitigate the adverse effects on health, the environment, safety, and corrosion, various methods have been proposed to minimize the risks that the handling of this contaminating agent permanently poses.

One of the strategies for removing and treating H₂S-rich fluids consists of the use of amines as chemical sequestrant agents, which have selectivity towards said molecule. The process is commonly performed on gas streams in contactor towers, wherein an amine-rich solution is thoroughly mixed with the gas stream under conditions of low temperatures and high pressures, allowing a reversible chemical reaction to occur between H₂S and the amine, thereby removing the H₂S of the gaseous effluent.

However, the H₂S absorption for amines has several drawbacks, such as foaming, scaling, and corrosion. In addition, the use of amines for the removal of H₂S is a two-stage process: absorption and regeneration, wherein the latter involves the release of H₂S to the atmosphere. This process involves high energy and capital costs and also generates secondary hazardous waste.

An alternative method consists of using triazine in direct conversion processes, i.e., processes wherein H₂S is taken to be finally brought to elemental sulfur. The triazine isomer used for this purpose is 1,3,5-tris(2-hydroxyethyl)-hexahydro-triazine. Generally, the triazine removal process is more economical for streams containing H₂S concentrations of a few hundred ppm. However, the use of triazine as an H₂S scavenger produces fouling during the downstream refining process due to the formation of a poorly soluble, white solid reaction product known as dithiazine polymer.

Controlled contact between triazine and H₂S is essential, as excessive contact, even with low H₂S concentrations, or minimal contact with high H₂S concentrations, can cause an overreaction with triazine, leading to polymerization and precipitation of dithiazine, which can then build up in pipes.

To address the problems caused by the use of amines or triazine, several alternative sequestrant agents have been developed. For example, U.S. Pat. No. 9,469,660B2 discloses a surface-modified particle including an hexahydrotriazine fragment covalently linked via an aminosilane bridge, which may include an alkyl chain having 2 to 14 carbon atoms or an aromatic bridge to said particle. The surface-modified particle can be used in processes for removing sulfur compounds from fluids.

In turn, Huang H. et al., (“Amine-Grafted MCM-48 and Silica Xerogel as Superior Sorbents for Acidic Gas Removal from Natural Gas.” Ind. Eng. Chem. Res. (2003) 42, 2427-2433), report the use of xerogel silica and mesoporous silica materials modified on the surface with amine groups, particularly (3-aminopropyl)triethoxysilane (APTES) useful in the adsorption of CO₂ and H₂S of natural gas flows.

However, given the growing concern about the removal of H₂S from wastewater to prevent health and environmental effects, safety issues, and corrosion, there is a persistent need to develop alternative compositions and methods that efficiently sequester H₂S in wastewater while also addressing the problems associated with the use of amines or triazine.

### BRIEF DESCRIPTION

In a first aspect, the present development refers to an H₂S sequestrant composition in wastewater comprising aminoorganoalkoxysilane-functionalized particles between 1 ppm and 20000 ppm, aminoorganoalkoxysilane-functionalized thickening agents between 0.01% w/w and 3% w/w, an adsorption promoter between 0.01% w/w and 8% w/w, and a polar solvent.

In a second aspect, the present development refers to an H₂S sequestrant composition, wherein the particles are selected from the group consisting of SiO₂, Ag, Au, TiO₂, ZnO, ZrO₂, and Fe₃O₂ particles.

In a third aspect, the present development refers to an H₂S sequestrant composition, wherein the aminoorganoalkoxysilane-functionalized particles are characterized by an average particle size between 1 nm and 6000 nm.

In a fourth aspect, the present development refers to an H₂S sequestrant composition, wherein the thickening agent is selected from hydroxyethylcellulose, carboxymethylcellulose (CMC), carboxyethylcellulose (CEC), carrageenan, guar gum, xanthan gum, gum arabic, carob bean gum, hemicellulose, and sodium carboxymethylcellulose and mixtures thereof.

In a fifth aspect, the present development refers to an H₂S sequestrant composition, wherein the aminoorganoalkoxysilanes are selected from (3-aminopropyl)triethoxysilane (APTES), (3-aminopropyl)trimethoxysilane, N-(β-aminoethyl)-γ-aminopropylmethyldimethoxysilane, N-3-trimethoxysilylpropyldiethylenetriamine, and mixtures thereof.

In a sixth aspect, the present development refers to an H₂S sequestrant composition, wherein the absorption promoter is selected from the group consisting of diethanolamine, monoethanolamine, triethanolamine, triethylenetetramine (TETA), diethylenetriamine, tris(2-aminoethyl)amine, ethylenediamine, 1,2-diaminopropane, tetraethylenepentamine, 1-hexadecylamine (HDA), aminoethylpiperazine (AEP), N,N′-bis-(2-aminoethyl)piperazine, N-(2-aminoethyl)piperazine, piperazinoethylenediamine (PEEDA), tetraethylenepentimine, pentaethylenehexamine, putrescine, cadaverine, norspermidine, spermidine, spermine, and mixtures thereof.

In a seventh aspect, the present development refers to an H₂S sequestrant composition, wherein the polar solvent is selected from water, ethanol, isopropyl alcohol, methanol, butyl glycol, and mixtures thereof.

In an eighth aspect, the present development refers to an H₂S sequestrant composition comprising APTES-functionalized SiO₂ particles between 5000 ppm and 20000 ppm, APTES-functionalized hydroxyethylcellulose between 0.01% w/w and 3% w/w, triethylenetetramine (TETA) between 0.1% w/w and 8% w/w, and water.

In a ninth aspect, the present development refers to a method for obtaining an H₂S sequestrant composition, comprising the steps of: hydroxylating the particles until at least 90% of the surface has OH— groups; functionalizing the hydroxylated particles and the thickening agent using aminoorganoalkoxysilanes; and mixing the functionalized thickening agent, the absorption promoter, and the functionalized particles with the solvent at a temperature between 10° C. and 30° C., under stirring between 400 rpm and 1300 rpm for 2 h to 8 h until obtaining the H₂S sequestrant composition in wastewater.

### BRIEF DESCRIPTION OF THE FIGURES

FIG. 1. Schematic representation of the hydroxylation process of SiO₂ particles.

FIG. 2. Schematic representation of the functionalization process with aminoorganoalkoxysilanes of SiO₂ particles.

FIG. 3. Schematic representation of the functionalization process with aminoorganoalkoxysilanes of the thickening agent.

FIG. 4. Surface electron micrographs of the particles synthesized from the composition A1-B1-C1.

FIG. 5. FTIR spectra of the bare, functionalized particles and particle-free sequestrant matrix synthesized under compositions A1, C1, and D1.

### DETAILED DESCRIPTION

To interpret the terms used throughout this document, its usual meaning in the technical field should be considered, unless a particular definition is incorporated or the context indicates otherwise. Additionally, terms used in the singular form will also include the plural form.

Unless otherwise indicated, implied from context, or customary in the art, all parts and percentages herein are based on weight.

### Product

The composition of the present development corresponds to an H₂S sequestrant composition in wastewater. For the purposes of this development, “H₂S sequestrant composition” refers to a composition based on a mixture of aminoorganoalkoxysilane-functionalized particles, aminoorganoalkoxysilane-functionalized thickening agents, and an absorption promoter in a polar solvent capable of capturing H₂S present in wastewater.

For the purposes of this development, the removal of H₂S present in wastewater occurs through the combined reaction of the amino groups on the particles and the aminoorganoalkoxysilane-functionalized thickening agents and the H₂S that, in the presence of the absorption promoter, allows the production of ammonium hydrogen sulfide (NH₄SH). In this sense, unlike conventional technologies, the sequestrant composition of this development keeps the H₂S species captured without subsequent release into the atmosphere.

For the purposes of this development, the H₂S sequestrant composition in wastewater comprises aminoorganoalkoxysilane-functionalized particles. The aminoorganoalkoxysilane-functionalized particles are characterized by an average particle size between 1 nm and 6000 nm; or between 10 nm and 4000 nm; or between 20 nm and 3000 nm; or between 25 nm and 1000 nm.

The aminoorganoalkoxysilane-functionalized particles are found in the H₂S sequestrant composition in a concentration between 1 ppm and 20000 ppm; or between 10 ppm and 1000 ppm; or between 1000 ppm and 5000 ppm; or between 5000 ppm and 10000 ppm; or between 1000 ppm and 15000 ppm; or between 15000 ppm and 20000 ppm. In the developed composition, the functionalized particles perform the function of transporting the amino groups in large amounts due to their greater surface area, allowing for better H₂S sequestration.

The particles are selected, but not limited to the group comprising SiO₂, Ag, Au, TiO₂, ZnO, ZrO₂, and Fe₃O₂ particles. For the purposes of the present invention, the particles may be synthesized by any method known in the art or purchased from certified commercial suppliers.

For the purposes of this development, the H₂S sequestrant composition comprises aminoorganoalkoxysilane-functionalized thickening agents. The aminoorganoalkoxysilane-functionalized thickening agents is found in the H₂S sequestrant composition in a concentration between 0.01% w/w and 3% w/w; or between 0.1% w/w and 0.4% w/w; between 0.4% w/w and 0.6% w/w; or between 0.6% w/w and 0.8% w/w; or between 0.8% w/w and 0.10% w/w; or between 0.10% w/w and 0.12% w/w; or between 0.14% w/w and 0.16% w/w; or between 0.16% w/w and 0.18% w/w; or between 0.1% w/w and 0.2, 9% w/w.

In particular, the thickening agent is selected from, but not limited to, the group comprising hydroxyethylcellulose, carboxymethylcellulose (CMC), carboxyethylcellulose (CEC), carrageenan, guar gum, xanthan gum, gum arabic, carob bean gum, hemicellulose, and sodium carboxymethylcellulose and mixtures thereof. In the developed composition, the functionalized thickening agent performs the function of promoting the absorption of H₂S on the product.

For the purposes of this development, the aminoorganoalkoxysilanes used to functionalize the particles and the thickening agent are selected from, but not limited to, the group comprising (3-aminopropyl)triethoxysilane (APTES), (3-aminopropyl)trimethoxysilane, N-(β-aminoethyl)-γ-aminopropylmethyldimethoxysilane, N-3-trimethoxysilylpropyldiethylenetriamine, and mixtures thereof.

In particular, the particles are characterized in that between 80% and 100% of the surface is functionalized with aminoorganoalkoxysilane and the thickening agent is characterized in that between 80% and 90% of the surface is functionalized with aminoorganoalkoxysilane. In particular, the functionalization of the surface of the particles and the thickening agent in the percentages indicated above perform the function of sequestering the H₂S particles, since both agents contain a large proportion of amino groups.

For the purposes of this development, the H₂S sequestrant composition comprises an absorption promoter. The absorption promoter is found in the H₂S sequestrant composition in a concentration between 0.01% w/w and 8% w/w; or between 0.1% w/w and 1% w/w, or between 1% w/w and 1.5% w/w; or between 1.5% w/w and 3% w/w; or between 3% w/w and 4.5% w/w; or between 4.5% w/w and 6% w/w; or between 6% w/w and 8% w/w.

In particular, the absorption promoting agent is selected from, but not limited to, the group consisting of diethanolamine, monoethanolamine, triethanolamine, triethylenetetramine (TETA), diethylenetriamine, tris(2-aminoethyl)amine, ethylenediamine, 1,2-diaminopropane, tetraethylenepentamine, 1-hexadecylamine (HDA), aminoethylpiperazine (AEP), N,N′-bis-(2-aminoethyl)piperazine, piperazinoethylenediamine (PEEDA), tetraethylenepentimine, pentaethylenehexamine, putrescine, cadaverine, norspermidine, spermidine, spermine, and mixtures thereof.

For the purposes of this development, the H₂S sequestrant composition in wastewater comprises a polar solvent, wherein the solvent is selected from, but not limited to, the group comprising water, ethanol, isopropyl alcohol, methanol, butyl glycol, and mixtures thereof.

In one embodiment of the present development, the H₂S sequestrant composition in wastewater comprises APTES-functionalized SiO₂ particles between 5000 ppm and 20000 ppm; APTES-functionalized hydroxyethylcellulose between 0.01% w/w and 3% w/w; triethylenetetramine (TETA) between 0.1% w/w and 8% w/w; and water, and wherein the APTES-functionalized SiO₂ particles are characterized by an average particle size between 1 nm and 6000 nm.

In one embodiment of the present development, the H₂S sequestrant composition in wastewater comprises:
Fe₃O₂ particles functionalized with (3-aminopropyl)trimethoxysilane between 6000 ppm and 10000 ppm;
carboxymethylcellulose (CMC) functionalized with (3-aminopropyl)trimethoxysilane between 0.5% w/w and 1.5% w/w;
triethanolamine between 2% w/w and 5% w/w; and
water;
   wherein the Fe₃O₂ particles have an average particle size between 2 nm and 30 nm.

In one embodiment of the present development, the H₂S sequestrant composition in wastewater comprises:
APTES-functionalized SiO₂ particles between 7000 ppm and 15000 ppm;
APTES-functionalized hydroxyethylcellulose between 0.5% w/w and 2% w/w;
triethylenetetramine (TETA) between 1% w/w up to 2% w/w; and
water;
   wherein the SiO₂ particles have an average particle size between 5 nm and 2000 nm.

In another embodiment of the present development, the H₂S sequestrant composition in wastewater comprises:
Fe₃O₂ particles functionalized with N-(β-aminoethyl)-γ-aminopropylmethyldimethoxysilane between 10000 ppm and 19000 ppm;
gum arabic functionalized with N-(β-aminoethyl)-γ-aminopropylmethyldimethoxysilane between 2% w/w and 3% w/w;
diethanolamine between 2% w/w and 6% w/w; and
water;
   wherein the Fe₃O₂ particles have an average particle size between 50 nm and 200 nm.

In another embodiment of the present development, the H₂S sequestrant composition in wastewater comprises:
Fe₃O₂ particles functionalized with N-3-trimethoxysilylpropyldiethylenetriamine between 6500 ppm and 8000 ppm;
gum arabic functionalized with APTES between 0.8% w/w and 1.8% w/w;
tetraethylenepentamine, between 3.5% w/w and 7.5% w/w; and
water;
   wherein the Fe₃O₂ particles have an average particle size between 5 nm and 10 nm.

### Method

Another object of the development is to provide a method for obtaining an H₂S sequestrant composition described above. The method for obtaining an H₂S sequestrant composition comprises the steps of:
a) hydroxylating the particles until at least 90% to 100% of the surface has OH— groups;
b) functionalizing the hydroxylated particles and the thickening agent using aminoorganoalkoxysilanes;
d) mixing the functionalized thickening agent, the absorption promoter, and the functionalized particles with the solvent at a temperature between 10° C. and 30° C., under stirring between 400 rpm and 1300 rpm for 2 h to 8 h until obtaining the H₂S sequestrant composition in wastewater.

According to the developed method, the hydroxylation of the particles is carried out by any method known in the art, for example, the particles are mixed with an aqueous solution of NaOH or KOH at a concentration between 1 w/w and 3 w/w at a temperature between 15° C. and 35° C., under stirring between 500 rpm and 1200 rpm, for 15 min to 45 min.

Subsequently, the hydroxylated particles are subjected to a sonication process for 1 h to 4 h under stirring between 500 rpm and 1200 rpm, maintaining the stirring for 15 h to 24 h more and, finally, they are separated by any known technique, for example, by centrifugation, washed with water, and dried between 40° C. and 70° C. for 15 h to 30 h.

According to the developed method, the functionalization of the hydroxylated particles is carried out by any method known in the art, for example, the hydroxylated particles are dispersed in an ethanol and ammonia solution at a concentration of 1:32 v/v, respectively, stirring conditions between 500 rpm and 900 rpm, a temperature between 70° C. and 75° C. for 30 min to 90 min. Subsequently, the aminoorganoalkoxysilane is added in a 1.8:1 w/w ratio to the hydroxylated particles, and stirring continues for 10 h to 20 h. The aminoorganoalkoxysilane-functionalized particles are separated using any known technique, for example, centrifugation, washed with a 50% w/w aqueous ethanol solution, and dried at 40° C. to 60° C. for 15 h to 30 h.

According to the developed method, the functionalization of the thickening agent is carried out by any method known in the art, for example, one part of the thickening agent is dissolved in 180 parts of water at a temperature between 15° C. and 25° C., between 300 rpm and 500 rpm for 15 min to 45 min. Once the thickener has dissolved, 0.1% w/w to 8% of the absorption promoter is added until it has completely dissolved and then the aminoorganoalkoxysilane is added under stirring between 300 rpm and 900 rpm at 15° C. and 25° C. for 1 h to 3 h.

Finally, the functionalized thickening agent, the absorption promoter, and the functionalized particles are mixed with the solvent at a temperature between 10° C. and 30° C., under stirring between 400 rpm and 1300 rpm for 2 h to 8 h until the H₂S sequestrant composition is obtained.

### Uses

The H₂S compositions in wastewater described herein are useful for reducing the H₂S concentration in wastewater. For the purposes of this development, the term “wastewater” refers to a mixture of H₂S, NH₃, and/or low molecular weight mercaptans, metals, and dissolved solids that normally produce odors and can cause severe problems in wastewater treatment plants, even in small amounts. The composition of the present development reaches H₂S sequestrant percentages between 70% w/w and 98% w/w.

For example, in one possible application, the sequestrant composition of the present development is dosed into the pipeline with a chemical injection pump. The injection site should be selected so that the location allows the H₂S sequestrant composition to be fully mixed and react with the liquid stream. The actual required dose of H₂S sequestrant composition depends on temperature and initial/final concentration of H₂S in the aqueous effluent.

This development will be detailed through the following examples, which are provided for illustrative purposes only and are not intended to limit its scope.

### EXAMPLES

### Example 1: Synthesis of SiO₂ Particles

The synthesis of SiO₂ particles was carried out following an acidic route and a basic route according to the conditions listed in Table 1.

For the acid route, solution A was prepared consisting of sodium silicate and water in a 1:10 w/w ratio. Separately, a second solution was prepared using 44% HCl and water. Solution B was added to solution A until a pH of 6.5 was reached under sonication. The mixture was kept under stirring at 500 rpm at 28° C. for 1 h until the SiO₂ particles were obtained. Subsequently, the resulting particles were separated by centrifugation, washed with ethanol, and, finally, dried at 50° C. for 24 h.

For the basic route, a mixture of ammonium hydroxide and ethanol was prepared in a 1:3 v/v ratio (solution C) and mixed with an aqueous solution of sodium silicate in a 1:14 v/v ratio (solution D) until a mixture of solutions D and C was obtained in a 1:16 v/v ratio. The resulting mixture was stirred at 500 rpm for 1 h. Finally, the particles were separated by centrifugation, washed with ethanol, and, finally, dried at 50° C. for 24 h.

From the two methodologies previously described, but modifying the reaction conditions, the SiO₂ particles A1 to A4 were obtained as shown in Table 1.

TABLE 1
Obtaining SiO₂ particles using different reaction conditions

| | A1 | A2 | A3 | A4 |
|---|---|---|---|---|
| Reaction Conditions | Acid Route | | Basic Route | |
| Reaction Catalyst | Hydro- | Tetra- | Sodium | Ammonia |
| | chloric | chloroauric | borohydride | |
| | acid | acid | | |
| Catalyst Amount [ml] | 13.8 | 4.2 | 66.7 | 66.7 |
| Sodium Silicate [g] | 50.7 | 50.7 | 39.5 | 39.5 |
| Water [ml] | 553 | 553 | 553 | 553 |
| Ethanol [ml] | 200 | 200 | 200 | 200 |
| Stirring [rpm] | 500 | 500 | 500 | 500 |
| Temperature [° C.] | 28 | 28 | 28 | 28 |
| Stirring Time [h] | 1 | 1 | 1 | 1 |

### Example 2: Method for Obtaining a H₂S Sequestrant Composition

### Hydroxylation of SiO₂ Particles

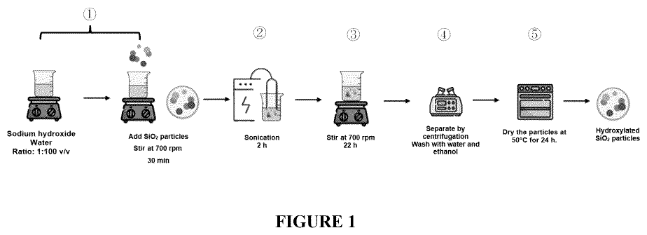

For hydroxylation, 100 g of SiO₂ particles (A1 to A4) were added on a solution of 27.3 g of NaOH in 2730 ml of water. The mixture was stirred at 700 rpm for 30 min (\textcircled{1} in FIG. 1). The mixture was subsequently sonicated for 2 h (\textcircled{2} in FIG. 1) and stirring was resumed at 700 rpm for 22 h (\textcircled{3} in FIG. 1). The hydroxylated particles were separated by centrifugation (\textcircled{4} in FIG. 1), washed with water, and dried at 50° C. for 24 h (\textcircled{5} in FIG. 1).

The above procedure was carried out by varying the amounts of water and NaOH, as well as the operating conditions to obtain particles B2 to B4 as shown in Table 2.

TABLE 2
Obtaining hydroxylated SiO₂ particles
using different reaction conditions

| Reaction Conditions | B1 | B2 | B3 | B4 |
|---|---|---|---|---|
| Sodium Hydroxide [g] | 27.3 | 27.3 | 55.4 | 55.4 |
| Water [ml] | 13.8 | 4.2 | 66.7 | 66.7 |
| SiO₂ particles | A1 | A2 | A3 | A4 |
| Stirring [rpm] | 700 | 800 | 1000 | 1000 |
| Temperature [° C.] | 28 | 28 | 28 | 28 |
| Stirring Time [h] | 22 | 22 | 10 | 10 |

Functionalization with Aminoorganoalkoxysilanes of Hydroxylated SiO₂ Particles

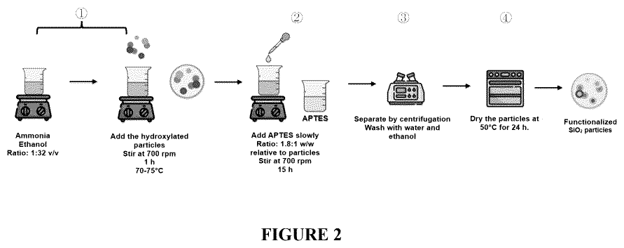

To carry out the functionalization of the particles with aminoorganoalkoxysilanes, 110 g of hydroxylated particles obtained according to Example 2 were added to a solution prepared with 10240 ml of 98% ethanol and 320 ml of 25% ammonia. The dispersion was stirred at 700 rpm at a temperature between 70° C. and 75° C. for 1 h (\textcircled{1} in FIG. 2). Subsequently, 180 g of (3-aminopropyl)triethoxysilane (APTES) was added and stirring was maintained at 700 rpm for 15 h at 75° C. (\textcircled{2} in FIG. 2).

Finally, the APTES-functionalized SiO₂ particles were separated by centrifugation (\textcircled{3} in FIG. 2), washed with a solution of 200 ml of ethanol in 200 ml of water, and dried at 50° C. for 24 h (\textcircled{4} in FIG. 2). The above procedure was carried out by varying the amounts of water and NaOH, as well as the operating conditions to obtain particles C1 to C4 as shown in Table 3.

TABLE 3
Obtaining APTES-functionalized SiO₂ particles
using different reaction conditions

| Reaction Conditions | C1 | C2 | C3 | C4 |
|---|---|---|---|---|
| Ammonia [ml] | 320 | 320 | 215 | 215 |
| Ethanol [ml] | 10500 | 10240 | 6450 | 6450 |
| Water [ml] | 4000 | 4000 | 2900 | 2900 |
| Formulation of Hydroxylated Particles | B1 | B2 | B3 | B4 |
| APTES [g] | 180 | 180 | 210 | 210 |
| Stirring [rpm] | 700 | 800 | 1000 | 1000 |
| Temperature [° C.] | 28 | 28 | 28 | 28 |
| Stirring Time [h] | 15 | 15 | 10 | 10 |

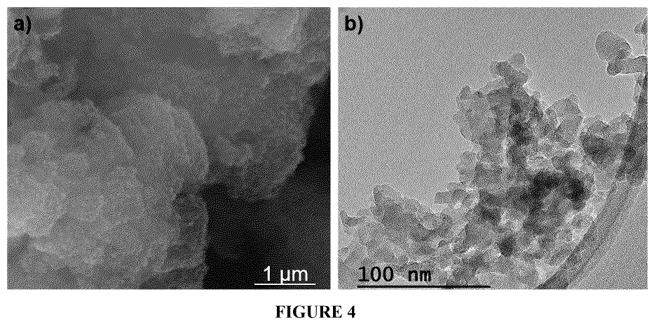

The functionalized particles were characterized by scanning electron microscopy (SEM) and transmission electron microscopy (TEM) using Quanta 650 FEG Environmental and Tecnai F20 Super Twin TMP microscopes, respectively. The SEM micrograph in FIG. 4a shows the functionalized SiO₂ particles forming agglomerates larger than 1 μm. The individual functionalized SiO₂ particles are detailed in the TEM micrograph in FIG. 4b with particle sizes in the range of 15 nm to 30 nm forming a chain agglomeration typical of this type of materials.

### Functionalization of the Aminoorganoalkoxysilane Thickening Agents

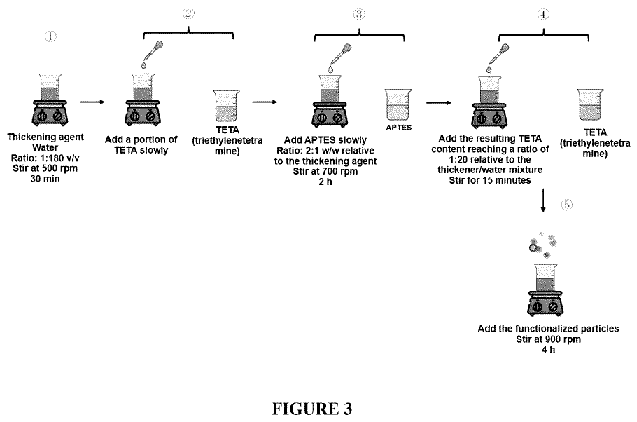

For functionalization of the thickening agent, 1 part of the thickening agent according to Table 4 was mixed with 180 parts of water under stirring of 500 rpm at a temperature of 25° C. for 30 min (\textcircled{1} in FIG. 3). Subsequently, 50 g of triethylenetetramine (TETA) was added (\textcircled{2} in FIG. 3) and after its complete integration the aminoorganoalkoxysilane (APTES) was added, maintaining the stirring at 500 rpm for 2 h (\textcircled{3} in FIG. 2). The resulting thickening agent was reserved to prepare the sequestrant composition.

TABLE 4
Functionalization of the APTES thickening agent using different reaction conditions

| Reaction Conditions | D1 | D2 | D3 | D4 |
|---|---|---|---|---|
| Thickening Agent | Hydroxyethylcellulose | Carboxyethylcellulose | Gum arabic | Xanthan gum |
| Thickening Agent Amounts [g] | 5 | 4.4 | 4.2 | 5.3 |
| Water [ml] | 935 | 800 | 750 | 950 |
| Absorption Promoter | 50 | 47 | 37 | 48 |
| APTES [g] | 10 | 8.8 | 8.4 | 10.6 |

### Obtaining the H₂S Sequestrant Composition

To prepare the H₂S sequestrant compositions of the present development, the functionalized thickening agent was mixed with the absorption promoter (TETA) at 500 rpm for 15 min (\textcircled{4} in FIG. 3). Immediately after, the functionalized particles were added and the stirring was increased between 700 rpm and 900 rpm for 4 h or 8 h at a temperature of 28° C. (\textcircled{5} in FIG. 3) until obtaining the H₂S sequestrant composition according to Table 5. In all cases, sufficient water was added to adjust the concentration of the components of each composition.

TABLE 5
H₂S sequestrant compositions using different
components and preparation conditions

| Composition | E1 | E2 | E3 | E4 |
|---|---|---|---|---|
| Functionalized Thickening Agent | D1 | D1 | D3 | D4 |
| Thickening Agent Amounts [g] | 5 | 4.4 | 4.2 | 5.3 |
| Water [ml] | 935 | 800 | 750 | 950 |
| Functionalized Particles | C1 | C2 | C3 | C4 |
| APTES [g] | 10 | 8.8 | 8.4 | 10.6 |
| TETA [g] | 50 | 47 | 37 | 48 |
| Stirring [rpm] | 900 | 900 | 700 | 700 |
| Temperature [° C.] | 28 | 28 | 28 | 28 |
| Stirring Time [h] | 4 | 4 | 8 | 8 |

### Example 3: Characterization of the Sequestrant Composition with APTES-Functionalized SiO₂ Particles

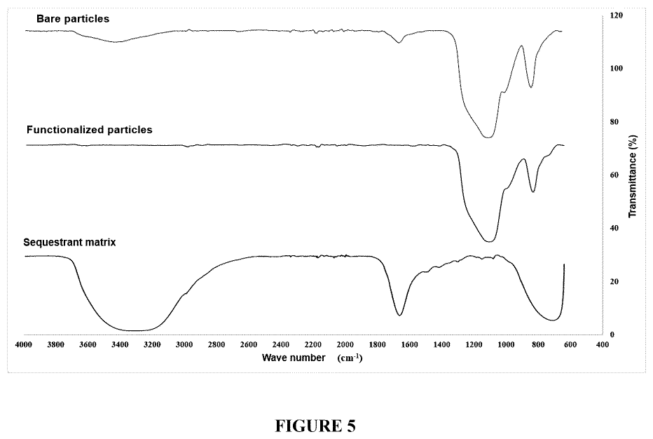

In order to identify the main functional groups of the bare, functionalized particles and the particle-free sequestrant composition, characterization was carried out using infrared spectroscopy on a SHIMADZU Model 84005 Fourier Transform Infrared (FTIR) spectrophotometer. The FTIR spectra of the analyzed samples are shown in FIG. 5.

The bare particles exhibit bands associated with the stretching and bending vibration of the O—H bond at 3400 cm⁻¹ and 1650 cm⁻¹ attributed to the silanol groups (Si—OH bonds) and water molecules adsorbed on the surface. In addition, the signals related to the symmetric and asymmetric stretching vibration of the Si—O—Si bonds are observed around 790 cm⁻¹ and 1100 cm⁻¹. Likewise, the presence of the Si—O—Si bond is observed at 790 cm⁻¹ and 1100 cm⁻¹.

In the functionalized particles, the signals associated with the OH groups are not observed, which represents an indication of the functionalization of the particles after interacting with the organoalkoxylane (APTES). Also, the signals towards 2911 cm⁻¹ and 1578 cm⁻¹ can be attributed to the stretching vibration of the characteristic C—H and N—H groups of the amino group.

The spectrum corresponding to the sequestrant composition without particles shows the presence of two bands around 3300 cm⁻¹ and 1650 cm⁻¹ associated with the stretching vibration and bending of the O—H groups in the hydroxyethylcellulose structure and the water molecules adsorbed on the surface. On the other hand, stretching vibration bands associated with the C—O—C bond in hydroxyethylcellulose were identified at 1101 cm⁻¹ and 1049 cm⁻¹, while the signals towards 1186 cm⁻¹, 1080 cm⁻¹, and 790 cm⁻¹ are related to the Si—O—C stretching vibration of the Si—O—CH₃ group in the organoalkoxysilane.

Additionally, the range of 1460-1383 cm⁻¹ shows a signal related to stretching vibrations of the C—N bond in the organoalkoxysilane and the absorption promoter, which is of an amine nature. It is important to note that the band associated with the vibration of the N—H bond contained in the absorption promoter may be masked in the band located at 1700 to 1500 cm⁻¹.

### Example 4: Compositions of the H₂S Sequestrant Agents

Following the same method described above and varying the components and concentration, the H₂S sequestrant compositions are prepared as indicated in Table 6.

TABLE 6
H₂S sequestrant compositions

| Composition | E5 | E6 | E7 | E8 | E9 |
|---|---|---|---|---|---|
| Type of | Fe₃O₄ | TiO₂ | Ag | ZrO₂ | SiO₂ |
| Particles | | | | | |
| Type of | Guar gum | Xanthan gum | Gum arabic | Carboxyethyl- | Hydroxyethyl- |
| Thickening | | | | cellulose | cellulose |
| Agent | | | | (CEC) | |
| Type of | N-(β-aminoethyl)-γ- | (3- | N-(β-aminoethyl)-γ- | (3- | (3- |
| Aminoorgano | aminopropylmethyl- | aminopropyl)tri- | aminopropylmethyl- | aminopropyl)tri- | aminopropyl)tri- |
| alkoxysilanes | bimethoxysilane | methoxysilane | bimethoxysilane | ethoxysilane | ethoxysilane |
| | | | | (APTES), | (APTES) |
| Concentration | | | | | |
| of | | | | | |
| Aminoorgano | 1 ppm | 5000 | 16000 | 20000 | 3000 |
| alkoxysilanes- | | | | | |
| functionalized | | | | | |
| Particles | | | | | |
| [ppm] | | | | | |
| Concentration | | | | | |
| of | | | | | |
| Aminoorgano | 0.1 | 0.5 | 0.8 | 0.9 | 1 |
| alkoxysilane- | | | | | |
| functionalized | | | | | |
| Thickening | | | | | |
| Agent | | | | | |
| [% w/w] | | | | | |
| Type of | Diethanolamine | Diethylenetriamine | Tris(2- | Triethanolamine | Monoethanolamine |
| Adsorption | | | aminoethyl)amine | | |
| Promoter | | | | | |
| Absorption | 0.5 | 0.3 | 0.8 | 0.5 | 1 |
| Promoter | | | | | |
| Concentration | | | | | |
| [% w/w] | | | | | |
| Solvent | Water | Ethanol | Ethanol | Water | Water |

### Example 5: Removal of the H₂S Sequestrant Agent in the Laboratory

Determining the percentage of H₂S removal in wastewater was carried out with a setup consisting of two flasks connected to a hose; Flask 1 contained 10 ml of wastewater with a concentration of 3000 ppm of H₂S, a pH of 8. And the H₂S sequestrant composition in a 5:1 ratio relative to the wastewater, while the second flask contained a 1M NaOH solution.

Nitrogen was then bubbled into Flask 1 in order to promote the escape of H₂S gas to flask number 2. After 15 minutes, the final concentration of NaOH in the second flask was calculated by acid-base titration with 1M HCl.

In case H₂S gas migrates through the hose into Flask 2, it will react with sodium hydroxide as shown in reaction (1).

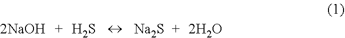

In this sense, the sequestrant agent would be expected to prevent the flow of H₂S towards Flask 2, preventing the progress of the reaction (1). Consequently, the concentration of NaOH would remain constant at approximately.

The procedure described above for the application essay was performed with each of the sequestrant compositions shown in Table 5. In addition, different ratios of sequestrant composition/wastewater were used according to Table 7.

TABLE 7
Determination of the percentage of H₂S removal in wastewater

| Essay | F1 | F2 | F3 | F4 |
|---|---|---|---|---|
| Sequestrant Composition/Wastewater [v/v] | 5:1 | 6:1 | 7:1 | 8:1 |
| NaOH [M] | 1M | 1M | 1M | 1M |
| H₂S [ppm] in Sour Water | 3000 | 3000 | 3000 | 3000 |
| pH | 8 | 8 | 8 | 8 |
| T [° C.] | 30 | 30 | 30 | 30 |
| Time [min] | 15 | 15 | 15 | 15 |

Additionally, an essay was carried out to determine the percentage of stripping, that is, the percentage of H₂S that the sequestrant composition could be released into the atmosphere once the pH of the treated water decreases.

For this purpose, the same assembly described above was used, but a sulfuric acid solution 1M H₂SO₄ was added to Flask 1 in order to lower the pH of the solution to a value of 1. After 30 minutes, an acid-base titration was performed in order to determine if there was a decrease in the NaOH concentration in case the H₂S gas escapes and reacts with the basic compound.

The procedure described above for the application essay was performed with each of the sequestrant compositions shown in Table 5. In addition, different ratios of sequestrant composition/wastewater were used according to Table 8.

TABLE 8
Determination of the percentage of H₂S stripping

| Essay | G1 | G2 | G3 | G4 |
|---|---|---|---|---|
| Sequestrant Agent/Wastewater Ratio [v/v] | 5:1 | 6:1 | 7:1 | 8:1 |
| NaOH [M] | 1M | 1M | 1M | 1M |
| H₂S [ppm] in Sour Water | 3000 | 3000 | 3000 | 3000 |
| H₂SO₄ | 1M | 1M | 1M | 1M |
| pH | 1 | 1 | 1 | 1 |
| T [° C.] | 30 | 30 | 30 | 30 |
| Time [min] | 30 | 30 | 30 | 30 |

1. An H₂S sequestrant composition comprising:
aminoorganoalkoxysilane-functionalized particles between 1 ppm and 20000 ppm;
aminoorganoalkoxysilane-functionalized thickening agent between 0.01% w/w and 3% w/w;
adsorption promoter between 0.01% w/w and 8% w/w; and
polar solvent.

2. The H₂S sequestrant composition according to claim 1, wherein the particles are selected from the group consisting of SiO₂, Ag, Au, TiO₂, ZnO, ZrO₂, and Fe₃O₂ particles.

3. The H₂S sequestrant composition according to claim 1, wherein the aminoorganoalkoxysilane-functionalized particles are characterized by an average particle size between 1 nm and 6000 nm.

4. The H₂S sequestrant composition according to claim 1, wherein the thickening agent is selected from hydroxyethylcellulose, carboxymethylcellulose (CMC), carboxyethylcellulose (CEC), carrageenan, guar gum, xanthan gum, gum arabic, carob bean gum, hemicellulose, sodium carboxymethylcellulose, and mixtures thereof.

5. The H₂S sequestrant composition according to claim 1, wherein the aminoorganoalkoxysilanes are selected from (3-aminopropyl)triethoxysilane (APTES), (3-aminopropyl)trimethoxysilane, N-(β-aminoethyl)-γ-aminopropylmethyldimethoxysilane, N-3-trimethoxysilylpropyldiethylenetriamine, and mixtures thereof.

6. The H₂S sequestrant composition according to claim 1, wherein the adsorption promoter is selected from the group consisting of diethanolamine, monoethanolamine, triethanolamine, triethylenetetramine (TETA), diethylenetriamine, tris(2-aminoethyl)amine, ethylenediamine, 1,2-diaminopropane, tetraethylenepentamine, 1-hexadecylamine (HDA), aminoethylpiperazine (AEP), N,N′-bis-(2-aminoethyl)piperazine, N-(2-aminoethyl)piperazine, piperazinoethylenediamine (PEEDA), tetraethylenepentimine, pentaethylenehexamine, putrescine, cadaverine, norspermidine, spermidine, spermine, and mixtures thereof.

7. The H₂S sequestrant composition according to claim 1, wherein the polar solvent is selected from water, ethanol, isopropyl alcohol, methanol, butyl glycol, and mixtures thereof.

8. The sequestrant composition according to claim 1 comprising:
APTES-functionalized SiO₂ particles between 5000 ppm and 20000 ppm;
APTES-functionalized hydroxyethylcellulose between 0.01% w/w and 3% w/w;
triethylenetetramine (TETA) between 0.1% w/w up to 8% w/w; and
water;
wherein the APTES-functionalized SiO₂ particles are characterized by an average particle size between 1 nm and 6000 nm.

9. A method for obtaining an H₂S sequestrant composition comprising the steps of:
a) hydroxylating the particles until at least 90% of the surface has OH— groups;
b) functionalizing the hydroxylated particles and the thickening agent using aminoorganoalkoxysilanes;
d) mixing the functionalized thickening agent, the absorption promoter, and the functionalized particles with the solvent at a temperature between 10° C. and 30° C., under stirring between 400 rpm and 1300 rpm for 2 h to 8 h until obtaining the H₂S sequestrant composition in wastewater.
